(19) United States
(12) Patent Application Publication
(10) Pub. No.: US 2009/0319419 A1
(43) Pub. Date: Dec. 24, 2009

(54) Method and apparatus for executing a win, lose or draw derivative contract

(76) Inventor: Bruce David Silverman, Minneapolis, MN (US)

Correspondence Address: Bruce D. Silverman, Apt. 339, 7160 Cahill Rd., Minneapolis, MN, 55439, US

(21) Appl. No.: 12/583,647

(22) Filed: Aug. 24, 2009

Related U.S. Application Data
(63) Continuation-in-part of application No. 11/484,223, filed on Jul. 11, 2006.
(60) Provisional application No. 60/698,122, filed on Jul. 11, 2005.

(51) Int. Cl. G06Q 40/00

(52) U.S. Cl. 705/37

(57) ABSTRACT

Methods and systems are disclosed for executing a fixed-payoff derivative contract between two parties that provide the opportunity to speculate on the movement of single-stock equities, equity indexes, bonds, commodities and currencies in a manner that eliminates the cost of an option premium. The invention, henceforth referred to as a “Win, Lose or Draw” derivative contract, is a cash position for or against the occurrence of a designated price event above an underlying financial instrument's spot price before a designated price event below an underlying financial instrument's spot price, or vice versa, within a designated time period. If neither designated price event occurs within the designated time period, no loss of cash position is incurred by either party. Additional embodiments include the application of asset-backed contracts, transferable positions, multiple underlying financial instruments within the same contract, and expirationless time periods.

### RELATED APPLICATIONS

The present application is a continuation-in-part of U.S. patent application Ser. No. 11/484,223, filed Jul. 11, 2006, which in turn claims the benefit of U.S. Provisional Patent Application No. 60/698,122, filed Jul. 11, 2005. Priority is claimed to both applications, the disclosures of which are hereby incorporated by reference.

### FIELD OF THE INVENTION

This application relates generally to derivative securities traded in a securities market; more particularly to a new form of securities derivative traded on a securities or commodities exchange or other suitable market; and more particularly still to a derivative product that provides win, lose or draw scenarios that involve fixed cash or asset-backed positions and fixed payoffs based on the price movements of one or more underlying financial instruments within a designated time frame.

### BACKGROUND OF THE INVENTION

The use of non-linear derivatives has become a widespread instrument and vital tool in the financial markets over the last thirty years, ever since the Black-Scholes formula for calculating the price of options was introduced in 1973. As with all non-linear derivatives created since that time, one of the fundamental aspects to trading such financial instruments is the pricing of the option, or what is known as the “premium.” Many variations of the Black-Scholes formula have been proposed and implemented, particularly formula variations that take into account the aspects of American-style options. Furthermore, many variations of options derivatives have been devised, including exotic options of varying characteristics and parameters, such as binary options, barrier options, double barrier options and double barrier digital options. Regardless of the parameters of these non-linear derivatives, they are typically subject to a premium—the cost of the option—that is tied to the underlying financial instrument, be that underlying instrument related to equities, commodities, bonds or currencies. Indeed, there are even non-linear derivatives on linear derivatives in the form of options on futures.

Despite the fact that these various permutations of non-linear derivatives are largely designed as a hedging instrument for mitigating risk, the potential for sizable losses still exists if a non-linear derivative such as a so-called “plain vanilla option” expires “out of the money” and the entire cost of the premium is lost, or even when such an option expires “in the money” but the final value of the option is less than the original premium paid. In other words, if expectations for the performance of an underlying instrument within a designated time frame do not meet a minimum criteria, at least some portion of the cost of the option premium will be lost. Still, one of the reasons non-linear derivatives, specifically options, offer so much appeal is because one will always know exactly the maximum amount of downside risk before taking a position—the cost of the premium—while the potential upside is theoretically limitless.

However, the theoretically limitless gains that can be realized in an options position usually has a topside implied by the volatility of the underlying instrument. Furthermore, because the cost of a premium is always at risk of losing value, traders have devised elaborate hedging strategies such as “delta hedging” to mitigate the risk of lost value. In other words, they are hedging against hedging strategies, creating financial maneuvers that can become very intricate, confusing and speculatively hazardous. These shortcomings of non-linear derivatives highlight the need for a simpler and safer approach to hedging, leveraging and speculating based on the movement of underlying financial instruments.

### SUMMARY OF THE INVENTION

The present invention offers a new approach to trading derivatives by introducing an instrument that eliminates the cost and risk associated with a premium. Just like existing derivatives, the new premium-free “Win, Lose or Draw” derivative contract is based on the speculative price movement of an underlying instrument within a designated period of time. But instead of offering the potential for unlimited gain along with the right (but not the obligation) to purchase the underlying instrument at a specified price in exchange for a premium, the premium-free Win, Lose or Draw derivative contract offers a predefined payoff derived indirectly from the implied volatility of the underlying instrument and dictates the exact gain or loss that would be realized for any position should one specified event occur before another specified event with respect to the underlying financial instrument before or at a designated expiration period. If neither specified event occurs, neither position is lost and the individuals holding the positions will only incur the cost related to the execution of a transaction, for example, a broker's fee, for executing a trade.

The key to understanding the distinction of the present invention is the introduction of a ratio of “implied probability” for either of two potential events occurring, specifically, the implied probability of one event occurring before the other event occurs with respect to an underlying financial instrument's spot price, within a designated time period.

A loose correlation would be to consider the so-called “place number” wagers in the game of Craps. This is a wager that a given number will occur before another given number occurs in the roll of the dice, specifically, bets for or against the occurrence of the individual number values 4, 5, 6, 8, 9 and 10 before the occurrence of the number value 7, or vice versa. If a winning event occurs, the wager is paid off according to the odds for the winning event occurring versus the losing event occurring, minus the casino's house edge. If neither a winning event or losing event occurs on any given roll of the dice, the wager is neither won nor lost.

In a Win, Lose or Draw derivative contract, two speculative prices for an underlying financial instrument—one above and one below the spot price of an underlying financial instrument—are the winning and losing events. If neither speculative price occurs before or at a designated expiry, then a position is neither won nor lost. However, unlike the game of Craps, where there are known probabilities based on 36 possible combinations for 11 possible outcomes, non-linear derivatives don't have inherent probabilities for specific events occurring. Instead, in order to calculate the payoff for a position in a Win, Lose or Draw contract, one must consider the implied volatility of the underlying instrument at any given spot price to determine the probability of the underlying instrument reaching one speculative price above the given spot price before reaching another speculative price below the given spot price, or vice versa. The ratio derived from the implied volatility of an underlying financial instrument with respect to the two speculative prices—one above and one below the spot price—is the implied probability ratio used to determine a cash or asset-backed position and speculative return.

The new premium-free Win, Lose or Draw contract can be executed as a “pure” derivative that does not have to be tied to ownership of the underlying instrument, but rather, provides a cash-based or asset-backed contract that matches a party who believes that the underlying instrument will reach a designated price above the spot price before the underlying instrument reaches a designated price below the spot price with a party who believes that the underlying instrument will reach the designated price below the spot price before the underlying instrument reaches the designated price above the spot price. Alternatively, the contract can also be structured as an asset-backed contract where the two parties hold positions in the underlying and some units of the underlying form the value of the two respective positions in the contract.

### BRIEF DESCRIPTION OF THE DRAWINGS

Various embodiments of the present invention are represented in certain parts and steps with reference to the following drawings and related descriptions:

FIG. 1 is a flow chart that depicts the general sequence of events according to an embodiment of the present invention.

FIG. 2 is a flow chart that depicts the general sequence of events according to an embodiment of the present invention.

FIG. 3 is a flow chart that depicts the general sequence of events according to an embodiment of the present invention.

### DETAILED DESCRIPTION OF THE INVENTION

The present invention introduces a new type of derivative instrument, specifically, a derivative that does not require a position in the underlying financial instrument to which the derivative is tied, nor the payment of a premium for a position in the contract. Instead, the new, premium-free “Win, Lose or Draw” contract introduces the concept of “implied probability” for determining a reward ratio for one designated speculative price event above a financial instrument's spot price occurring before another designated speculative price event below the financial instrument's spot price, and vice versa, within a specified period of time. If neither speculative price event occurs within the specified period of time, neither party loses the value of their position.

In a preferred embodiment of the invention, a Win, Lose or Draw contract is tied to the spot price of a single underlying financial instrument. The underlying may be an equity listing such as a common stock, an index listing such as the S&P 500, a commodities future such as corn or gold, a bond, an interest rate, a volatility index, or any currency. In such an embodiment, each of two parties, either of which may or may not be a market maker or exchange specialist, would respectively assume a cash or asset-backed position based on any number of factors. For example, a typical options position is based on an equivalent of 100 shares per contract multiplied by the cost of the premium per share for that option. The same metric can be applied to Win, Lose or Draws for establishing a cash position. This does not preclude the use of other metrics such as establishing a standard contract equal to a fixed dollar amount, such as $100 per contract or determining a number of shares of the underlying to form an asset-backed position.

The likelihood, that is, the implied probability of one speculative price event above the spot price occurring before the other speculative price event below the spot price, and vice versa, with regard to the underlying financial instrument's spot price at any given point in time is determined by considering the implied volatility of the underlying instrument as reflected by a metric such as option strike price premiums, where the premium for a Call strike price above the underlying instrument's spot price is compared to the premium for a Put strike price below the underlying instrument's spot price, and the comparison establishing the likelihood of one strike price—that is, one speculative price event—being realized before the other strike price—that is, the other speculative price event—within the same period of time. This does not preclude the use of other metrics and mathematical models to determine an implied probability ratio.

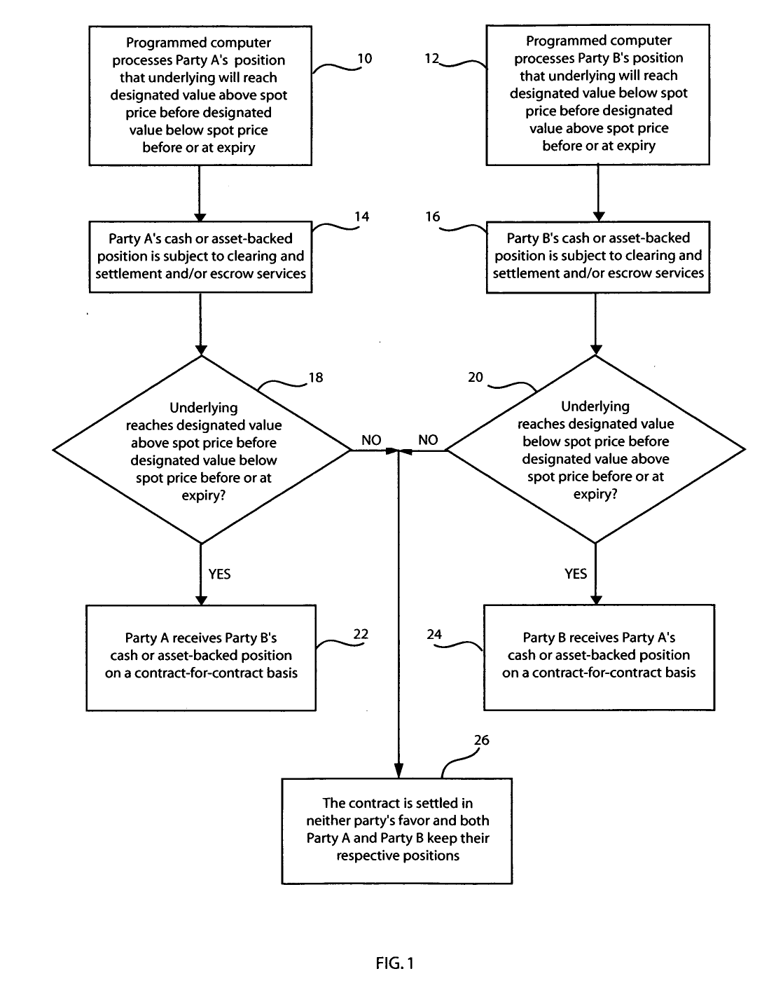

FIG. 1 represents the general sequence of events for one embodiment of the invention, regardless of the metric used to determine the “implied probability” ratio, which in turn is applied to determine the size of a position and fixed return for either party. The computer-implemented sequence of events begins at step 10, where Party A takes a cash or asset-backed position that the underlying will reach a designated value above the spot price before reaching a designated value below the spot price before or at expiry and at step 12, where Party B takes the opposite cash or asset-backed position that the underlying will reach the designated value below the spot price before reaching the designated value above the spot price before or at expiry. Party A's position is subject to clearing and settlement and/or escrow services at step 14 and Party B's position is subject to clearing and settlement and/or escrow services at step 16. At step 18, it is determined if the underlying reaches the designated value above the spot price before the designated value below the spot price before or at expiry or, conversely, at step 20, if the underlying reaches the designated value below the spot price before reaching the designated value above the spot price before or at expiry. If the underlying reaches the designated value above the spot price before the designated value below the spot price before or at expiry, then Party A receives Party B's position on a contract-for-contract basis at step 22. Conversely, if the underlying reaches the designated value below the spot price before reaching the designated value above the spot price before or at expiry, then Party B receives Party A's position on a contract-for-contract basis at step 24. If at steps 18 and 20, it is determined that the underlying reaches neither designated value above nor below the spot price before or at expiry, then the contract is settled in neither party's favor and both Party A and Party B keep their respective cash or asset-backed positions at step 26. It will be appreciated that this sequence of events does not take into account the transaction costs associated with the trade.

In one cash-based embodiment of the invention, the metric used to determine the implied probability ratio, cash positions and fixed payoffs can be the strike price premiums for Calls and Puts above and below the spot price for a common underlying and expiry. TABLE 1 below denotes symbols and formulas that can be used to illustrate such a cash-based embodiment.

TABLE 1

X = Spot Value of Underlying
S1 = Call Strike Price Above X
S2 = Put Strike Price Below X
P1 = S1 Premium
P2 = S2 Premium
F1 = P2 ÷ P1
F2 = P1 ÷ P2
D1 = P1 × 100 × # of contracts
D2 = P2 × 100 × # of contracts
S1 before S2 = (F1 × D1) + D1*
S2 before S1 = (F2 × D2) + D2*
*Total Return is the payoff realized on the position plus the original cash position.

In this application, where X denotes the underlying, the Call strike price above the spot price for the underlying, denoted by the symbol S1, has a corresponding premium denoted by the symbol P1, and the Put strike price below the spot price for the underlying, denoted by the symbol S2, has a corresponding premium denoted by the symbol P2.

Because the premiums for standard American and European options (often referred to as plain, vanilla options) reflect implied volatility for the underlying, one embodiment of the invention uses the values of the respective premiums (P1 and P2) specific to an underlying's spot price at any given point in time to establish an implied probability of a Call strike price above the underlying spot price occurring before a Put strike price below the underlying's spot price and vice versa before or at a common expiry. In other words, one embodiment of the invention compares a Call strike price premium above the underlying's spot price with a Put strike price premium below the underlying's spot price, within the same expiration period, to determine the likelihood of one strike price occurring before the other strike price within the same expiration period. By using a Call strike price that is “out of the money” and a Put strike price that is out of the money as two respective target prices, one creates a reasonable, speculative scenario as to which direction an underlying instrument might move from a common starting point. It is the ratio of the two strike price premiums relative to the spot price of an underlying at any given time that is used to determine the implied probability of one strike price being reached before the other strike price, and subsequently, the cash positions and potential, fixed payoff for each party that holds a position in a Win, Lose or Draw contract.

If one is taking a position that a designated Call strike price (S1) above the underlying's spot price will occur before a designated Put strike price (S2) below the underlying's spot price within the same designated time period, his cash position, represented by the symbol D1, would be the cost of the Call strike price premium (P1) multiplied by 100 multiplied by the number of contracts for his position. Conversely, if one is taking a position that a designated Put strike price (S2) below the underlying's spot price will occur before a designated Call strike price (S1) above the underlying's spot price within the same designated time period, his cash position, represented by the symbol D2, would be the cost of the Put strike price premium (P2) multiplied by 100 multiplied by the number of contracts for his position.

If the designated Call strike price should occur before the designated Put strike price for the given underlying within the designated time period, the party that holds the Call position would receive a payoff based on the implied probability of the Call strike price being reached relative to the Put strike price being reached, where the factor (F1), by which his cash position (D1) would be multiplied to determine his payoff, would be the Put strike price premium (P2) divided by the Call strike price premium (P1). That payoff would then be added to his original cash position (D1), and the sum credited to his account, less any trade transaction fees.

Conversely, if the designated Put strike price should occur before the designated Call strike price for any given underlying within the designated time period, the party that holds the Put position would receive a payoff based on the implied probability of the Put strike price being reached relative to the Call strike price being reached, where the factor (F2), by which he would multiply his cash position (D2) to determine his payoff, would be the Call strike price premium (P1) divided by the Put strike price premium (P2). That payoff would then be added to his original cash position (D2), and the sum credited to his account, less any trade transaction fees.

In other words, if the Call strike price is reached before the Put strike price, the party holding the Call position would receive the cash position for the party holding the Put position on a contract-for-contract basis. If the Put strike price is realized before the Call strike price, the party holding the Put position would receive the cash position of the party holding the Call position on a contract-for-contract basis. As stated earlier, if neither strike price is reached before or at expiry, no loss of cash position is incurred by either party.

It will be appreciated that in place of preexisting stock option tables, dedicated Win, Lose or Draw probability tables with their own target prices above and below an underlying's spot price and specific time frames or expires can be formulated and applied as tools for determining cash positions and payoffs for Win, Lose or Draw contract positions. The mathematical models used to determine the implied probability ratio for such tables can be as simple as the comparison of the distance of each of two Win, Lose or Draw target prices above and below an underlying's spot price, or they can involve more intricate mathematical models that take into account the underlying's history of upward volatility versus downward volatility, time to expiration and/or other deterministic factors.

The following example will help illustrate how one embodiment of a Win, Lose or Draw trade might transpire, using a hypothetical underlying and hypothetically available option strike prices and premiums as a metric for determining the implied probability ratio, which in turn is used to establish the cash positions and potential predetermined payoff for the two parties:

Suppose the underlying in question is the common stock for company XYZ. Company XYZ's stock price at a given point in time—the spot price—is $25 per share. At the same point in time, the June 30 Calls for XYZ have a premium of $1 per share and the June 22½ Puts have a premium of $2 per share. The implied volatility of the underlying reflected by the premiums of the two strike prices suggest that within the same time period, the underlying stock price for XYZ is twice as likely to reach $22½ per share as $30 per share. Applying the basic probability principle that the true-odds payoff for one event occurring before another event is the probability of the losing event occurring divided by the probability of the winning event occurring, then the true-odds payoff for XYZ reaching $30 per share before $22½ per share is 2:1. Conversely the true odds payoff for XYZ reaching $22½ per share before $30 per share is 1:2.

Continuing with the example, let's say that Party A assumes a one-contract Win, Lose or Draw cash position that the stock price for the underlying XYZ will reach $30 per share before reaching $22½ per share before or at the June expiry and Party B is willing to take the opposite position that the underlying XYZ will reach $22½ per share before reaching $30 per share before or at the June expiry. Party A's cash position, equivalent to 100 shares at a premium of $1 per share would be $100. Party B's cash position, equivalent to 100 shares at a premium of $2 per share would be $200. If the underlying reaches $30 per share before $22½ per share before or at the June expiry, Party A's payoff would be 2:1, or $200, which would be added to Party A's original $100 cash position for a total return of $300 that would be credited to Party A's account and Party B would lose his $200 cash position. Conversely, if the underlying reaches $22½ per share before $30 per share before or at the June expiry, Party B's payoff would be 1:2, or $100, which would be added to Party B's original $200 cash position for a total return of $300 that would be credited to Party B's account and Party A would lose his $100 cash position. If the underlying reaches neither $30 per share nor $22½ per share before or at the June expiry, Party A would keep his original $100 cash position and Party B would keep his original $200 cash position. It will be appreciated that cash positions and total return figures exclude any trade transaction fees.

Using the example above, the figures for the symbols and formulas in Table 1 above would read as follows in Table 2 below:

TABLE 2

X = $25
S1 = $30
S2 = $22½
P1 = $1
P2 = $2
F1 = 2
F2 = 0.5
D1 = $100
D2 = $200
$30 before $22½ (S1 before S2) = (F1 × D1) + D1 =
(2 × $100) + $100 = $300*
$22½ before $30 (S2 before S1) = (F2 × D2) + D2 =
(0.5 × 200) + $200 = $300*
*Total Return is the payoff realized on the position plus the original cash position.

It will be appreciated that the total potential return for either position in a Win, Lose or Draw contract can be expressed as being the same for either party on a contract-for-contract basis. This can be further demonstrated in Table 3 below by using the distributive property to show the two events “S1 before S2” and “S2 before S1” are both equal to 100N(P1+P2) where “N” is the number of contracts:

TABLE 3

$\begin{matrix}S 1 before S 2 = ( F 1 \times D 1 ) + D 1 \\ = ( P 2 / P 1 \times P 1 \times 100 \times N ) + ( P 1 \times 100 \times N ) \\ = ( P 2 / P 1 — \times P 1 — \times 100 \times N ) + ( P 1 \times 100 \times N ) \\ = ( P 2 \times 100 \times N ) + ( P 1 \times 100 \times N ) \\ = 100 N ( P 2 + P 1 )\end{matrix}$
$\begin{matrix}S 2 before S 1 = ( F 2 \times D 2 ) + D 2 \\ = ( P 1 / P 2 \times P 2 \times 100 \times N ) + ( P 2 \times 100 \times N ) \\ = ( P 1 / P 2 — \times P 2 — \times 100 \times N ) + ( P 2 \times 100 \times N ) \\ = ( P 1 \times 100 \times N ) + ( P 2 \times 100 \times N ) \\ = 100 N ( P 1 + P 2 )\end{matrix}$

It will also be appreciated, that in a sufficiently liquid market, either party holding a position in a Win, Lose or Draw contract might choose to close out their position before expiry, as long as neither designated price event has occurred, by selling their position.

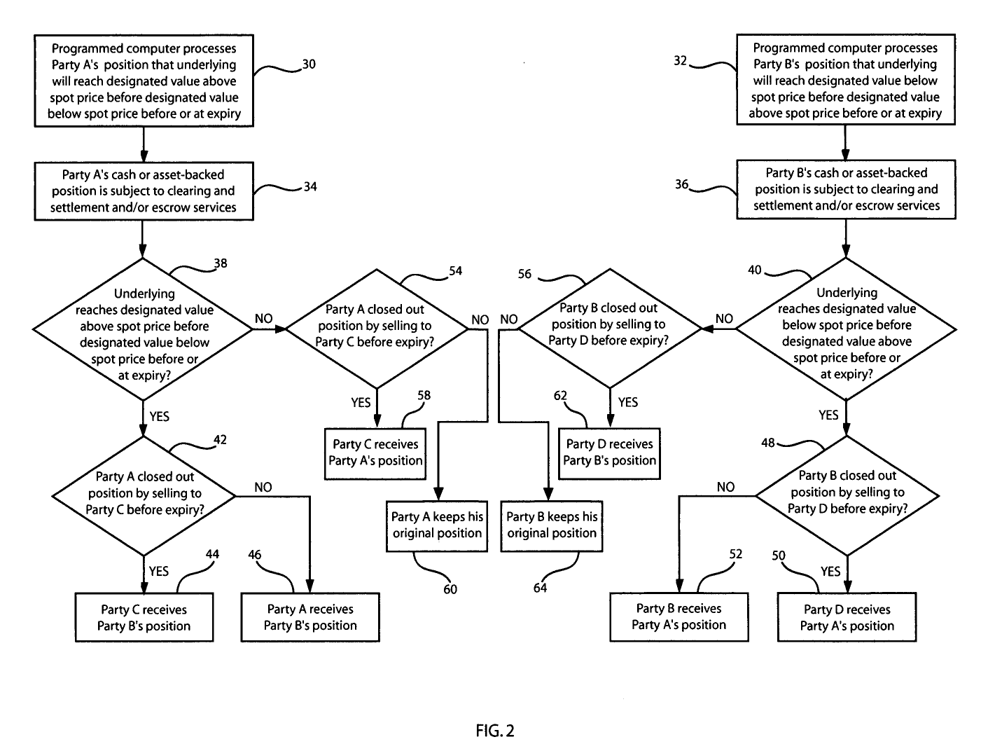

FIG. 2 represents the general sequence of events for another embodiment of the invention in which the two original parties that hold a position in a Win, Lose or Draw contract have the option to close out their positions before expiry, essentially transferring ownership of their position. The computer-implemented sequence of events begins at step 30, where Party A takes a cash or asset-backed position that the underlying will reach a designated value above the spot price before reaching a designated value below the spot price before or at expiry, and at step 32, where Party B takes the opposite cash or asset-backed position that the underlying will reach the designated value below the spot price before reaching the designated value above the spot price before or at expiry. Party A's position is subject to clearing and settlement and/or escrow services at step 34 and Party B's position is subject to clearing and settlement and/or escrow services at step 36. At step 38, it is determined if the underlying reaches the designated value above the spot price before the designated value below the spot price before or at expiry, and at step 40 it is determined if the underlying reaches the designated value below the spot price before reaching the designated value above the spot price before or at expiry. If the underlying reaches the designated value above the spot price before the designated value below the spot price before or at expiry, then at step 42 it is determined if Party A closed out his position by selling his position to Party C before expiry. If it is determined that Party A closed out his position to Party C at step 42, then Party C receives Party B's position at step 44. If it is determined that Party A did not close out his position at step 42, then Party A receives Party B's position at step 46. Conversely, if the underlying reaches the designated value below the spot price before the designated value above the spot price before or at expiry, then at step 48 it is determined if Party B closed out his position by selling his position to Party D before expiry. If it is determined that Party B closed out his position to Party D at step 48, then Party D receives Party A's position at step 50. If it is determined that Party B did not close out his position at step 48, then Party B receives Party A's position at step 52. If it is determined at step 38 and step 40 that the underlying reaches neither designated target value before or at expiry, then it is determined if either or both parties closed out their respective positions to Party C and Party D before expiry at step 54 and step 56. If at step 54, it is determined that Party A closed out his position to Party C, then Party C receives Party A's position at step 58. If at step 54 it is determined that Party A did not close out his position, then Party A keeps his original position at step 60. Likewise, if at step 56, it is determined that Party B closed out his position to Party D before expiry, then Party D receives Party B's position at step 62. If it is determined at step 56 that Party B did not close out his position, then Party B keeps his original position at step 64.

It will be appreciated that this sequence of events does not take into account the transaction costs associated with the trade. Additionally, it will be appreciated that the same sequence of events can take place over multiple purchases for the same original contract.

Continuing with the cash-based example, suppose the spot price of company XZY has moved upward from $25 per share at the time Party A and Party B initiated the contract to a current spot price of $28 per share within the same June expiration period. At the time the contract was created, the implied probability of the XYZ reaching $22½ per share was twice as great as XYZ reaching $30 per share. However, at this updated spot price with regard to the expiration period, the implied probability has changed so that it is now three times as likely for XYZ to reach $30 per share before or at expiry as it is to reach $22½ per share before or at expiry. So now if one were to take a position in a June Win, Lose or Draw contract where the spot price for XYZ is $28 per share, the following factors would determine the size of the position and potential return, where the premium on a June 30 XYZ Call is $1.50 and a June 22½ XYZ Put is $0.50.

Table 4 below denotes the updated values of the symbols from Table 2 when XYZ has a spot price of $28 per share within the same expiration period.

TABLE 4

X = $28
S1 = $30
S2 = $22½
P1 = $1.50
P2 = $.50
F1 = .333
F2 = 3.0
D1 = $150
D2 = $50
$30 before $22½ (S1 before S2) = (F1 × D1) + D1 =
(.333 × $150) + $150 = $200*
$22½ before $30 (S2 before S1) = (F2 × D2) + D2 =
(3.0 × 50) + $50 = $200*
*Total Return is the payoff realized on the position plus the original cash position.

Suppose now, Party C comes along and wants to take a position that XYZ will reach $30 per share before $22½ per share before or at the June expiry when the spot price is $28 per share. He would have to put up $150 to receive a $50 payoff versus the $100 Party A paid for the contract to receive a $200 payoff. Suppose also, despite the current $28 spot price, Party A has some trepidation about the price of XYZ reaching $30 per share before expiry and wishes to sell (to close out) his position in exchange for locking in a profit. Meanwhile, Party C is convinced that XYZ will indeed reach $30 per share before expiry. But rather than open a new position with a 33% return ratio, Party C makes Party A an offer that is more advantageous than opening a new position. So Party C, who might be an individual trader or a market maker, offers to buy Party A's position for $200, ensuring Party A a $100 profit on his original $100 position. This proves advantageous for Party C as well should XYZ reach $30 per share before $22½ per share, because he will receive Party A's total return of $300 if XYZ reaches $30 per share before $22½ per share, thereby realizing a 50 percent return on his money rather than a 33 percent return on his money if he opened a new position at the current $28 spot price. On the other hand, if Party C buys Party A's position and XYZ does an about-face and reaches 22½ before 30 before expiry, Party A will have still realized a $100 profit (thanks to the $200 Party C paid directly to him), Party B receives a $300 total return (his original $200 position plus Party A's original $100 position), and Party C is out the $200 he paid directly to Party A. If neither price event occurs, Party C receives Party A's original $100 cash position since he now owns Party A's position, and he assumes a $100 net loss since he paid Party A $200 for his position.

Suppose also, that at the $28 spot price, Party B is panicking because he's afraid that XYZ will reach $30 per share before expiry and he will lose his entire cash position. He doesn't want to lose his entire $200, so he tries to close out his position at a loss that is less than $200. Party D comes along and sees that at the current spot price of $28 per share, the June Win Lose or Draw contract position for $22½ per share occurring before $30 per share carries an implied probability of one in three and a payoff of 3:1. Party D, who also might be an individual trader or market maker, makes Party B an offer for his position that is more advantageous than opening a new position. He makes Party B an offer of $60 for his contract position. Party B is very nervous and figures losing $140 is better than losing his entire $200 position and closes out his position to Party D. So now if the stock does an about-face and XYZ manages to reach $22½ per share before reaching $30 per share within the June expiration period, Party D will have paid $60 to receive a net return of $240 and a total return of $300 versus paying $50 to receive a net return of $150 and a total return of $200 if he opened a new position when XYZ was at $28 per share. This is equivalent to a 400% return on his cash outlay versus the 300% return if he were to open a new position with the spot price for XYZ at $28 per share. On the other hand, if XYZ does indeed climb to $30 per share first, then Party D will be out the $60 he paid for Party B's position. However, the good news for Party D is that if neither designated price event occurs by expiry, then he receives Party B's original $200 cash position since he now owns that contract position, netting him a gain of $140 . . . a 233% net return on the $60 he paid to purchase Party B's position in the contract.

Once again, it will be appreciated that any number of metrics and mathematical models might be used to determine the implied probability ratio that determines the cash or asset-backed position and potential return when opening, closing, or buying out a Win, Lose or Draw position. Such formulas can be as simple as the comparison of the distance of each of two Win, Lose or Draw target prices above and below an underlying's spot price, or they can involve more intricate mathematical models that take into account the underlying's history of upward volatility versus downward volatility, time to expiration and/or other deterministic factors.

It will be appreciated that the various embodiments of the invention can also be applied across different underlyings within the same contract, where one party is taking the position that a first given underlying will reach a target price relative to its spot price before a second given underlying reaches a target price relative to its spot price, and vice versa, before expiry.

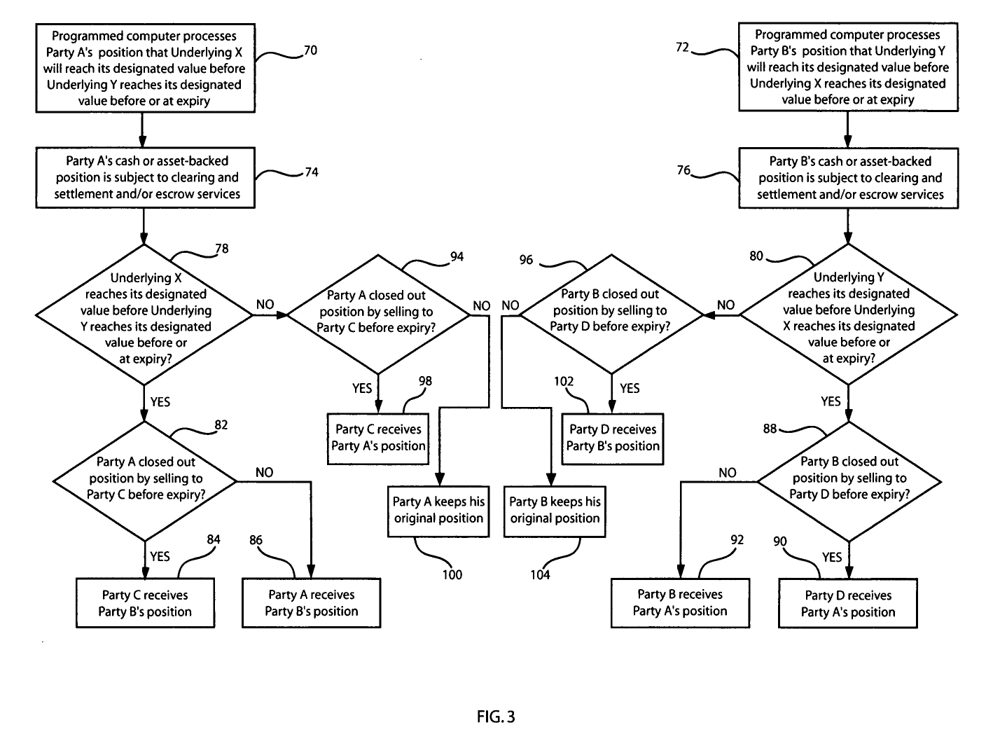

FIG. 3 represents the general sequence of events for another embodiment of the invention in which the two speculative price events involve two different underlyings and where the two original parties that hold the position in the contract once again have the option to close out their positions before expiry, essentially transferring ownership of their position. The computer-implemented sequence of events begins at step 70, where Party A takes a cash or asset-backed position that Underlying X will reach a designated value relative to its spot price before Underlying Y reaches a designated value relative to its spot price before or at expiry, and at step 72 where Party B takes the opposite cash or asset-backed position that Underlying Y will reach the designated value relative to its spot price before Underlying X reaches the designated value relative to its spot price before or at expiry. Party A's position is subject to clearing and settlement and/or escrow services at step 74 and Party B's position is subject to clearing and settlement and/or escrow services at step 76. At step 78, it is determined if Underlying X reaches its designated value before Underlying Y reaches its designated value before or at expiry, and at step 80 it is determined if Underlying Y reaches its designated value before Underlying X reaches its designated value before or at expiry. If it is determined that Underlying X reaches its designated value before Underlying Y reaches its designated value, then at step 82 it is determined if Party A closed out his position by selling his position to Party C before expiry. If it is determined that Party A closed out his position to Party C at step 82, then Party C receives Party B's position at step 84. If it is determined that Party A did not close out his position at step 82, then Party A receives Party B's position at step 86. Conversely, if it is determined that Underlying Y reaches its designated value before Underlying X reaches its the designated value, then at step 88 it is determined if Party B closed out his position by selling his position to Party D before expiry. If it is determined that Party B closed out his position to Party D at step 88, then Party D receives Party A's position at step 90. If it is determined that Party B did not close out his position at step 88, then Party B receives Party A's position at step 92. If it is determined at step 78 and step 80 that neither underlying reaches their respective designated values before or at expiry, then it is determined if either or both parties closed out their respective positions by selling them to Party C and Party D before expiry at step 94 and step 96. If at step 94, it is determined that Party A closed out his position to Party C, then Party C receives Party A's position at step 98. If at step 94 it is determined that Party A did not close out his position, then Party A keeps his original position at step 100. Likewise, if at step 96, it is determined that Party B closed out his position to Party D before expiry, then Party D receives Party B's position at step 102. If it is determined at step 96 that Party B did not close out his position, then Party B keeps his original position at step 104. It will be appreciated that this sequence of events does not take into account the transaction costs associated with the trade. Additionally, it will be appreciated that the same sequence of events can take place over multiple purchases for the same original contract.

In yet another embodiment of the invention, which is asset-backed instead of cash-based, a position in a Win, Lose or Draw contract can consist of shares of the underlying rather than cash. In such an embodiment, the spot price of the underlying at the time of the contract can be multiplied by a standardized number of shares or units per contract and then that value applied to an implied probability factor to determine the respective positions. However, in this scenario, because D1 and D2 represent the positions of the respective parties in shares or units of an underlying, it will be appreciated that the designated target prices at which the contract would be won or lost must also be taken into consideration in determining the size and potential return of the respective positions. That is, once an implied probability factor is applied to the spot price and contract size as a base for determining the dollar value equivalent of a position, it must be divided by the share price at which the counterparty would win the contract to determine the true-odds, dollar-to-share equivalent position of a party and subsequent potential payoff for the counterparty relative to the spot price of the underlying at the time the contract was created.

Returning to the original scenario where Party A is taking the position that XYZ will reach $30 per share before $22½ per share before or at expiry at a spot price of $25 per share, and Party B is taking the opposite position, one embodiment outlines a share-based contract that would be calculated as such in Table 5 and Table 6 below:

TABLE 5

X = Spot Value of Underlying
S1 = Call Strike Price Above X
S2 = Put Strike Price Below X
P1 = S1 Premium
P2 = S2 Premium
D1 = P1 × X (spot price) × 100 shares × # of contracts ÷ S2
D2 = P2 × X (spot price) × 100 shares × # of contracts ÷ S1
S1 before S2 = D2 + D1*
S2 before S1 = D1 + D2*

TABLE 6

X = $25
S1 = $30
S2 = $22½
P1 = $1
P2 = $2
D1 = 1 × $25 × 100 shares ÷ 2.25 = 111.11 shares of XYZ
D2 = 2 × $25 × 100 shares ÷ 30 = 166.66 shares of XYZ
$30 before $22½ (S1 before S2) = D2 + D1 = 277.78 shares*
$22½ before $30 (S2 before S1) = D1 + D2 = 277.78 shares*
*Total Return is the return on the position plus the Party's original position, in shares.

In the above scenario, with XZY having a spot price of $25 and 100 shares of XYZ as the metric determining the size of a contract, then if XYZ were to reach $30 before 22½ before expiry, Party A would receive Party B's 166.66 shares plus his own original position of 111.11 shares for a total return of 277.78 shares. Conversely, if XYZ reached $22½ before $30, then Party B would receive Party A's 111.11 shares plus his own original 166.66 share's for a total return of 277.78 shares.

It will be appreciated that fractional shares won and lost in such an embodiment can be rounded down to the nearest share with the remaining fractional share value being settled on a cash basis. Additionally, it will be appreciated that a combination of shares and cash can be used to establish a position if a party did not have a sufficient number of shares to cover the entire size of his position.

Finally, it will also be appreciated that with an adequately liquid market, embodiments of the invention can be accommodated where the predetermined time frame for a Win, Lose or Draw contract is essentially expirationless. That is, by using mathematical models that take into account various deterministic factors to formulate an implied probability of one designated price event occurring before another designated price event with respect to a given underlying's spot price, on an expirationless basis, a reasonably liquid market would allow two parties to hold on to their respective positions indefinitely until one of the designated price events occurs or allow them to close out their positions by selling them to other parties as long as neither designated price event has occurred. In other words, in an expirationless Win, Lose or Draw contract, any given party's position would remain active until one of the designated price events occurred or the party closed out their position to another party.

Those skilled in the art will recognize that the computer hardware and software infrastructure required to implement a product specific to the invention can easily be adapted from technology already widely in use. Furthermore, those skilled in the art will recognize that the legal and logistical requirements for establishing, issuing, listing and trading a new type of derivative on the various exchanges are also well understood.

Computer programs embodied in a computer-readable medium, for executing instructions on a processor, can instantly calculate Win, Lose or Draw contracts based on any number of varying metrics that determine the size and potential return of the respective positions in a contract, thereby allowing traders to see exactly what they would stand to gain or lose from a position in a contract at any point in time and place trades accordingly.

Those skilled in the art will also recognize that these systems and mechanisms may or may not involve brokerage houses, securities exchanges, commodities exchanges, clearing houses and/or escrow services as well as market makers to help ensure a liquid market in the trading of products specific to the invention. Computer hardware and software programs implemented by clearing house services can provide the necessary due diligence in executing and settling a Win, Lose or Draw contract. Alternatively, or in concert with said brokerage houses, clearing houses and exchanges, computer hardware and software programs implemented by escrow services can record cash or asset-backed positions for Win Lose or Draw contracts and/or hold cash or asset-backed positions in an escrow account until the outcome of a contract is determined. It will also be appreciated that the computer-implemented methods specific to the invention may be applied to over-the-counter trading platforms as well as exchange-traded platforms.

As stated earlier, the invention can be applied to any financial instrument with listed options. Additionally, dedicated Win, Lose or Draw probability tables based on dedicated target prices for any given underlying financial instrument can be calculated and listed, either as a dedicated tool for creating a liquid market in Win, Lose or Draw contracts or strictly for those underlying financial instruments that do not carry traditionally listed options.

The advantages of the various embodiments of the present invention are manifold. As stated earlier, it eliminates the risk of an option decreasing in value or expiring worthless if the performance of an underlying comes up short of expectations. If one is confident that an underlying financial instrument is going to move in a certain direction, either for purely speculative purposes or hedging purposes, but is not confident as to the extent of the movement, a Win, Lose or Draw contract offers insurance against a substantial loss. This in turn reduces the need for elaborate hedging strategies because a Win, Lose a Draw contract reduces the risk associated with an option's eroded time value and the constant fluctuations in the price of the underlying. Furthermore, it also provides an excellent method of hedging against a long or short position in an underlying instrument without having to write a Covered Call or Put and risk having a position in the underlying asset called away.

Additionally, it provides a win, lose or draw situation for volatile and short-term speculative market environments with the confidence of knowing that if an anticipated move in a given direction for an underlying is correct but comes up short of expectations, one would not lose any of his position, aside from the transaction fee.

Moreover, the invention can provide unique methods of speculating based on a laddering approach to designated price events. For example, a party can assume multiple positions comprising the occurrence of progressively higher price events relative to an underlying's spot price before the occurrence of one or more lower price events relative to an underlying's spot price, and vice versa, within the same time period or spread out over multiple time periods. Additionally, these multiple positions can be bundled into a single trade transaction. To this effect, a single Win, Lose or Draw contract can be constructed to provide the potential for multiple payoffs over time, assuming the absence of the occurrence of a losing price event.

Exchanges can generate revenue by either making a market for Win, Lose or Draw contracts as well as by charging brokerages for the right to offer the derivative and for providing clearing house services, either as a straight-out fee or licensing right, or as a percentage of the trading transaction fees generated by brokerage houses from their retail and/or institutional clients.

Yet another way that brokerages, exchanges and clearing houses can generate revenue is to retain a small percentage of the payoff on successful contract positions as a fee. So, for example, if a party received a $200 net return on a Win, Lose or Draw position, and a fee of 1% was excised, then instead of a payoff of $200, the party would receive $198 and the brokerage, exchange and clearing house can share the $2 proceeds.

It is to be understood that the embodiments shown and described herein are merely illustrative of the principles of this invention and that various modifications may be implemented by those skilled in the art without departing from the scope and spirit of the invention.

1-24. (canceled)

25. A computer-implemented method of defining and listing a derivative product for trading on an exchange or over-the-counter trading platform, comprising:
a) designating, by means of a programmed computer, a first price event relative to the spot price of a first underlying financial instrument;
b) designating, by means of a programmed computer, a second price event relative to the spot price of a second underlying financial instrument;
c) designating, by means of a programmed computer, a common time frame for either designated price event to occur; and
d) designating, by means of a programmed computer, predetermined payoffs, wherein:
i) a first predetermined payoff is based at least in part on the occurrence of the first designated price event before the occurrence of the second designated price event within the designated time frame; and
ii) a second predetermined payoff is based at least in part on the occurrence of the second designated price event before the occurrence of the first designated price event within the designated time frame.

26. The computer-implemented method of claim 25, wherein the spot price for any given underlying financial instrument is defined as the current market price or any suitable quoted or posted price for the underlying financial instrument at any given point in time.

27. The computer-implemented method of claim 25, wherein the first underlying financial instrument and the second underlying financial instrument are the identical underlying financial instrument.

28. The computer-implemented method of claim 27, wherein the first designated price event comprises an exact price above the spot price of the underlying financial instrument or any price above the exact price.

29. The computer-implemented method of claim 27, wherein the second designated price event comprises an exact price below the spot price of the underlying financial instrument or any price below the exact price.

30. The computer-implemented method of claim 25, wherein the designated time frame is expirationless.

31. A computer-implemented method of executing a derivative contract between two parties, comprising:
a) receiving and processing, by means of a programmed computer, a first order on behalf of a first party for a first cash or asset-backed position, the first position comprising parameters including at least a first predetermined payoff based at least in part on the occurrence of a first designated price event relative to the spot price of a first underlying financial instrument before the occurrence of a second designated price event relative to the spot price of a second underlying financial instrument within a predetermined time frame;
b) receiving and processing, by means of a programmed computer, a second order on behalf of a second party for a second cash or asset-backed position, the second position comprising parameters including at least a second predetermined payoff based at least in part on the occurrence of the second designated price event relative to the spot price of the second underlying financial instrument before the occurrence of the first designated price event relative to the spot price of the first underlying financial instrument within the predetermined time frame;
c) matching and processing, by means of a programmed computer, the first and second orders into a contract between the two parties; and
d) determining the outcome and settling the contract between the two respective parties, by means of a programmed computer, wherein:
i) the contract is settled in the first party's favor by means of at least the first predetermined payoff if the first designated price event occurs before the second designated price event within the predetermined time frame;
ii) the contract is settled in the second party's favor by means of at least the second predetermined payoff if the second designated price event occurs before the first designated price event within the predetermined time frame; and
iii) the contract is settled in neither party's favor if neither designated price event occurs within the predetermined time frame.

32. The computer-implemented method of claim 31, wherein any given underlying financial instrument is defined as one of a set of underlying financial instruments, the set including all single-stock equities, equity indexes, bonds, bond indexes, single-stock futures, equity index futures, volatility indexes, interest rates, interest rate indexes, commodities, commodity futures, commodity index futures, currencies, currency indexes, currency futures and currency index futures.

33. The computer-implemented method of claim 31, wherein the spot price for any given underlying financial instrument is defined as the current market price or any suitable quoted or posted price for the underlying financial instrument at any given point in time.

34. The computer-implemented method of claim 31, wherein the first underlying financial instrument and the second underlying financial instrument are the identical underlying financial instrument.

35. The computer-implemented method of claim 34, wherein the first designated price event comprises an exact price above the spot price of the underlying financial instrument or any price above the exact price.

36. The computer-implemented method of claim 34, wherein the second designated price event comprises an exact price below the spot price of the underlying financial instrument or any price below the exact price.

37. The computer-implemented method of claim 31, wherein the first underlying financial instrument and the second underlying financial instrument are not identical underlying financial instruments.

38. The computer-implemented method of claim 31, wherein the predetermined time frame is a finite time frame.

39. The computer-implemented method of claim 31, wherein the predetermined time frame is expirationless.

40. The computer-implemented method of claim 31, wherein either position held by either party may be sold to another party before the outcome of the contract is determined.

41. The computer-implemented method of claim 31, further comprising the participation of one or more exchanges and/or brokerage houses and/or clearing houses and/or escrow services to facilitate the execution of the contract.

42. A programmed computer system for executing a derivative contract between two parties, comprising:
a) a computer program product embodied in a computer-readable medium for executing instructions on a processor to receive and process a first order on behalf of a first party for a first cash or asset-backed position, the first position comprising parameters including at least a first predetermined payoff based at least in part on the occurrence of a first designated price event relative to the spot price of a first underlying financial instrument before the occurrence of a second designated price event relative to the spot price of a second underlying financial instrument within a predetermined time frame;
b) a computer program product embodied in a computer-readable medium for executing instructions on a processor to receive and process a second order on behalf of a second party for a second cash or asset-backed position, the second position comprising parameters including at least a second predetermined payoff based at least in part on the occurrence of the second designated price event relative to the spot price of the second underlying financial instrument before the occurrence of the first designated price event relative to the spot price of the first underlying financial instrument within the predetermined time frame;
c) a computer program product embodied in a computer-readable medium for executing instructions on a processor to match and process the first and second orders into a contract between the two parties; and
d) a computer program product embodied in a computer-readable medium for executing instructions on a processor to determine the outcome and settle the contract between the two respective parties, wherein:
i) the contract is settled in the first party's favor by means of at least the first predetermined payoff if the first designated price event occurs before the second designated price event within the predetermined time frame;
ii) the contract is settled in the second party's favor by means of at least the second predetermined payoff if the second designated price event occurs before the first designated price event within the predetermined time frame; and
iii) the contract is settled in neither party's favor if neither designated price event occurs within the predetermined time frame.

43. The system of claim 42, wherein the spot price for any given underlying financial instrument is defined as the current market price or any suitable quoted or posted price for the underlying financial instrument at any given point in time.

44. The system of claim 42, wherein the first underlying financial instrument and the second underlying financial instrument are the identical underlying financial instrument.

45. The system of claim 44, wherein the first designated price event comprises an exact price above the spot price of the underlying financial instrument or any price above the exact price.

46. The system of claim 44, wherein the second designated price event comprises an exact price below the spot price of the underlying financial instrument or any price below the exact price.

47. The system of claim 42, wherein the predetermined time frame is expirationless.

48. The system of claim 42, wherein either position held by either party may be sold to another party before the outcome of the contract is determined.
